(19) United States
(12) Patent Application Publication
(10) Pub. No.: US 2016/0125727 A1
(43) Pub. Date: May 5, 2016

(54) COMMUNICATION DEVICE AND EMERGENCY HELP METHOD

(71) Applicant: FIH (HONG KONG) LIMITED, Kowloon (HK)

(72) Inventor: WANG-HUNG YEH, New Taipei (TW)

(21) Appl. No.: 14/735,580

(22) Filed: Jun. 10, 2015

(30) Foreign Application Priority Data
Oct. 30, 2014 (TW) 103137531

(51) Int. Cl. G08B 25/01; H04W 4/02; H04W 4/22

(52) U.S. Cl. CPC G08B 25/016; H04W 4/22; H04W 4/02

(57) ABSTRACT

An emergency help method executable on a communication device having a display device, at least one processor, a navigation device, and a storage device includes detecting whether a predetermined emergency button is triggered, the navigation device is accessed to acquire a current position information of the communication device after the emergency button is triggered; the acquired current position information is integrated into a preset message template to generate a sendable emergency message, and then the sendable emergency message is send to one or more preselected emergency contacts.

### CROSS-REFERENCE TO RELATED APPLICATIONS

This application claims priority to Taiwanese Patent Application No. 103137531 filed on Oct. 30, 2014, the contents of which are incorporated by reference herein.

### FIELD

The subject matter herein generally relates to emergency communication technology, and particularly to a communication device and an emergency help method.

### BACKGROUND

A communication device (e.g., a smart phone or a tablet computer) is used for conveniently contacting others. But it is inconvenient and inefficient for getting help if a call is not answered.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a communication device.

FIG. 2 is a block diagram of one embodiment of function modules of an emergency help system in the communication device in FIG. 1.

FIG. 3 illustrates a flowchart of one embodiment of a method for getting help with the communication device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

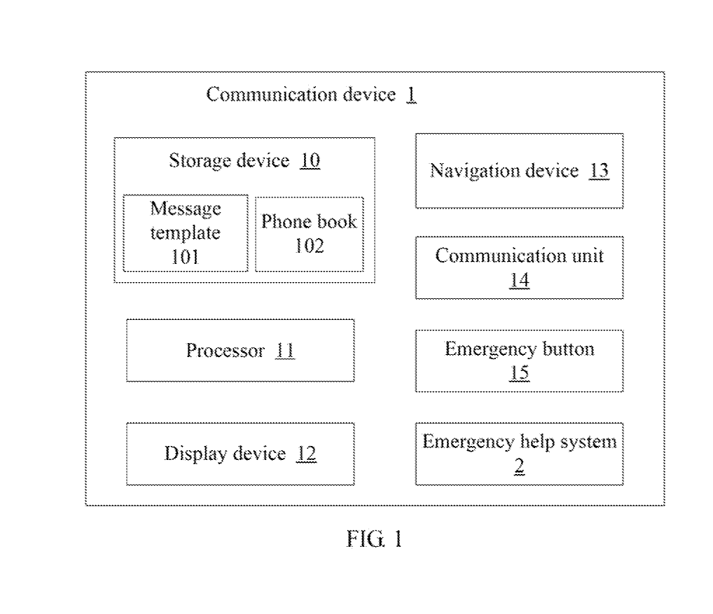

FIG. 1 illustrates a block diagram of one embodiment of a communication device. In at least one embodiment as shown in FIG. 1, a communication device 1 includes, but is not limited to, a storage device 10, at least one processor 11, a display device 12, a navigation device 13, a communication unit 14, and an emergency help system 2. The communication device 1 can be a tablet computer, a smart phone, a personal digital assistant (PDA), or any other communication device. FIG. 1 illustrates only one example of the communication device 1 that can include more or fewer components than illustrated, or have a different configuration of the various components in other embodiments.

In at least one embodiment, the storage device 10 can include various types of non-transitory computer-readable storage medium. For example, the storage device 10 can be an internal storage system, such as a flash memory, a random access memory (RAM) for temporary storage of information, and/or a read-only memory (ROM) for permanent storage of information. The storage device 10 can also be an external storage system, such as a hard disk, a storage card, or a data storage medium.

In at least one embodiment, the at least one processor 11 can be a central processing unit (CPU), a microprocessor, or other data processor chip that performs function of the emergency help system 2 in the communication device 1.

In at least one embodiment, the display device 12 can be a touch screen, which support multi-touch, such as resistive touch screens or capacitive touch screens.

In at least one embodiment, the navigation device 13 can use GPS satellite, A-GPS satellite, or GPS-ONE satellite, to monitor and acquire a current position information of the communication device 1. The current position information, for example, can comprise latitude and longitude, or information of county, city, province of country.

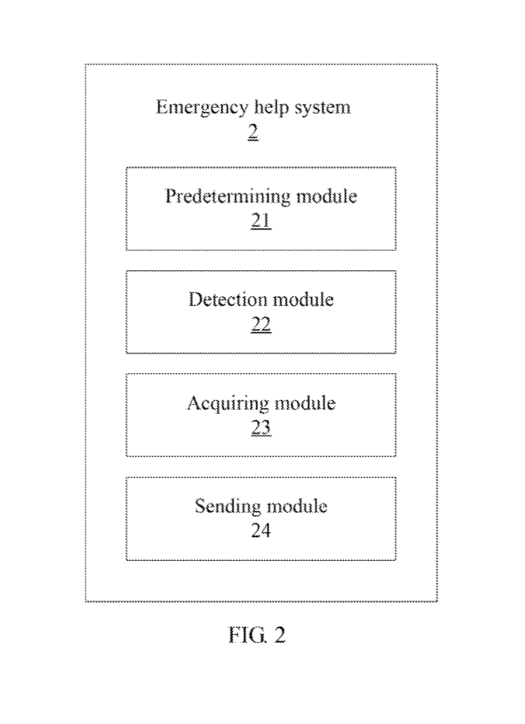

FIG. 2 is a block diagram of one embodiment of function modules of an emergency help system. In at least one embodiment, an emergency help system 2 can include a predetermining module 21, a detection module 22, an acquiring module 23, and a sending module 24. The function modules 21, 22, 23, and 24 can include computerized codes in the form of one or more programs, which are stored in the storage device 10 of the communication device 1. The at least one processor 11 executes the computerized codes to provide functions of the function modules 21-24.

The predetermining module 21 can preselect one or more emergency contacts and predetermine an emergency button 15, and preset a message template 101. The emergency contacts and the message template 101 can be stored in the storage device 10 of the communication device 1.

In at least one embodiment, the one or more emergency contacts can be preselected from a list of a phone book 102.

In at least one embodiment, the predetermined emergency button 15 can be a physical key of the communication device 1, a combination of physical keys of the communication device 1, or a virtual icon on a user interface displayed on the display device 12 of the communication device 1.

In some embodiments, the preset message template 101 comprises content: “Please help me, my current position is XX/XX.”

The detection module 22 can detect whether the predetermined emergency button 15 is triggered.

In some embodiments, if the emergency button 15 is a physical key or a combination of physical keys, the emergency button 15 is deemed triggered when the physical key or the combination is pushed.

In other embodiments, if the emergency button 15 is a virtual icon on the user interface displayed on the display device 12, the emergency button 15 is deemed triggered when the icon is pressed throughout a predetermined time period (e.g., five seconds). Furthermore, if the emergency button 15 is a virtual icon, the emergency button 15 can be displayed on both a locked screen of the display device 12, and an unlocked screen of the display device 12.

The generation module 23 can integrate a current position information of the communication device 1 into the preset message template 101 to generate a sendable emergency message. The current position information of the communication device 1 is acquired by the navigation device 13 which is activated after the emergency button 15 is triggered. For example, when the current position information of the communication device is (La, Lo), then, the sendable emergency message may be “Please help me, my current position is La/Lo.”

The sending module 24 can send the sendable emergency message to the one or more preselected emergency contacts by a communication unit 14 of the communication device 1.

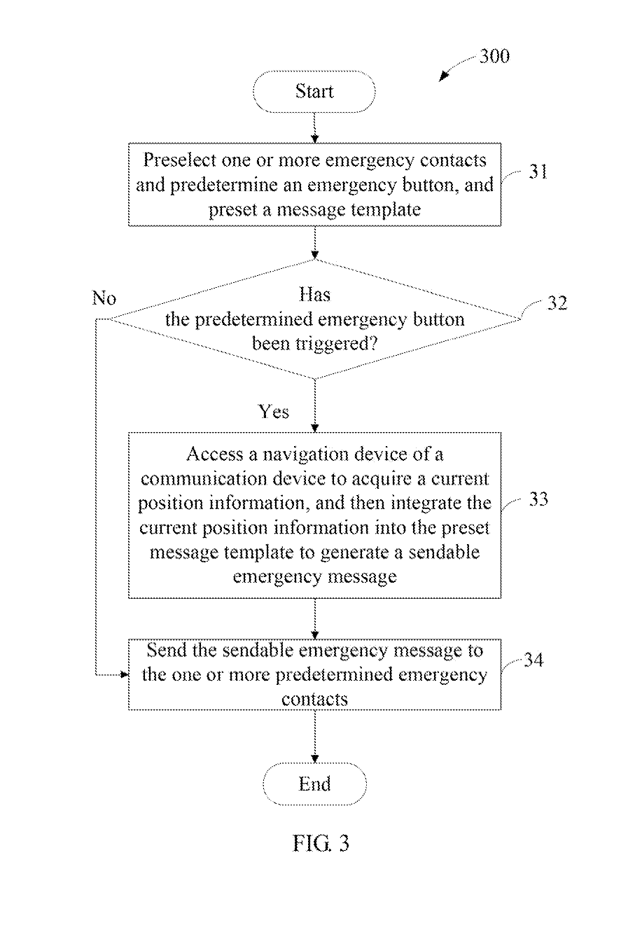

Referring to FIG. 3, a flowchart is presented in accordance with an example embodiment. An example method 300 is provided by way of example, as there are a variety of ways to carry out the method. The example method 300 described below can be carried out using the configurations illustrated in FIG. 1 and FIG. 2, for example, and various elements of these figures are referenced in explaining example method 300. Each block shown in FIG. 3 represents one or more processes, methods, or subroutines, carried out in the example method 300. Furthermore, the illustrated order of blocks is by example only and the order of the blocks can be changed. The example method 300 can begin at block 31. Depending on the embodiment, additional blocks can be added, others removed, and the ordering of the blocks can be changed.

At block 31, a predetermining module predetermines preselects one or more emergency contacts and predetermines an emergency button 15, and presets a message template 101.

At block 32, a detection module detects whether the predetermined emergency button 15 is triggered. If the detection module detects the predetermined emergency button 15 is triggered, the procedure goes to block 33; if the detection module does not detect the predetermined emergency button 15 is triggered, the procedure ends.

At block 33, the navigation device 13 of the communication device 1 is activated to acquire a current position information of the communication device 1 when the emergency button 15 is triggered, and then a generation module integrates the acquired current position information into the preset message template 101 to generate a sendable emergency message.

At block 34, a sending module sends the sendable emergency message to one or more preselected emergency contacts.

For example, a user predetermines two emergency contacts (e.g., San Zhang and Si Li), when the detection module detects the predetermined emergency button 15 is triggered, the navigation device 13 of the communication device 1 is activated, the navigation device 13 acquires that a current position information of the communication device 1 is “121.10/24.972”, then the generation module integrates the “121.10/24.972” into a preset message template 101 to generate a sendable emergency message, at the end, the sending module sends the sendable emergency message comprising content: “Please help me, my current position is 121.10/24.972.” to San Zhang and Si Li.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An emergency help method executable on a communication device, the communication device comprising a display device, at least one processor, a navigation device, and a storage device for storing one or more programs, the method comprising:
detecting, using the at least one processor, whether a predetermined emergency button is triggered;
accessing the navigation device to acquire a current position information of the communication device, when the emergency button is triggered;
integrating, using the at least one processor, the acquired current position information into a preset message template stored in the storage device to generate a sendable emergency message; and
sending the sendable emergency message to one or more preselected emergency contacts.

2. The method according to claim 1, wherein the position information comprises latitude and longitude.

3. The method according to claim 1, wherein the emergency button is selected from: a physical key of the communication device, a combination of physical keys of the communication device, and a virtual icon on a user interface displayed on the display device.

4. The method according to claim 3, wherein if the emergency button is a physical key or a combination of physical keys, the emergency button is triggered, upon condition that the physical key or the combination is pushed.

5. The method according to claim 3, wherein if the emergency button is a virtual icon on the user interface displayed on the display device, the emergency button is triggered upon condition that the icon is pressed throughout a predetermined time period.

6. The method according to claim 1, wherein the preset message template comprises content: “Please help me, my current position is XX/XX.”.

7. A communication device comprising:
a display device;
at least one processor;
a navigation device; and
a storage device that stores one or more programs which, when executed by the at least one processor, cause the at least one processor to:
detect, using the at least one processor, whether a predetermined emergency button is triggered;
access the navigation device to acquire a current position information of the communication device, when the emergency button is triggered;
integrate, using the at least one processor, the acquired current position information into a preset message template stored in the storage device to generate a sendable emergency message; and
send the sendable emergency message to one or more preselected emergency contacts.

8. The communication device according to claim 7, wherein the position information comprises latitude and longitude.

9. The communication device according to claim 7, wherein the emergency button is selected from: a physical key of the communication device, a combination of physical keys of the communication device, and a virtual icon on a user interface displayed on the display device.

10. The communication device according to claim 9, wherein if the emergency button is a physical key or a combination of physical keys, the emergency button is triggered, upon condition that the physical key or the combination is pushed.

11. The communication device according to claim 9, wherein if the emergency button is a virtual icon on the user interface displayed on the display device, the emergency button is triggered upon condition that the icon is pressed throughout a predetermined time period.

12. The communication device according to claim 7, wherein the preset message template comprises content: “Please help me, my current position is XX/XX.”.

13. A non-transitory storage medium having stored thereon instructions that, when executed by at least one processor of a communication device, causes the at least one processor to perform a method for emergency help, the communication device comprising a display device and a navigation device, wherein the method comprises:
detecting, using the at least one processor, whether a predetermined emergency button is triggered;
accessing the navigation device to acquire a current position information of the communication device, when the emergency button is triggered;
integrating, using the at least one processor, the acquired current position information into a preset message template stored in the storage device to generate a sendable emergency message; and
sending the sendable emergency message to one or more preselected emergency contacts.

14. The non-transitory storage medium according to claim 13, wherein the position information comprises latitude and longitude.

15. The non-transitory storage medium according to claim 13, wherein the emergency button is selected from: a physical key of the communication device, a combination of physical keys of the communication device, and a virtual icon on a user interface displayed on the display device.

16. The non-transitory storage medium according to claim 15, wherein if the emergency button is a physical key or a combination of physical keys, the emergency button is triggered, upon condition that the physical key or the combination is pushed.

17. The non-transitory storage medium according to claim 15, wherein if the emergency button is a virtual icon on the user interface displayed on the display device, the emergency button is triggered upon condition that the icon is pressed throughout a predetermined time period.

18. The non-transitory storage medium according to claim 13, wherein the preset message template comprises content: “Please help me, my current position is XX/XX.”.
